(19) United States
(12) Patent Application Publication
(10) Pub. No.: US 2005/0264883 A1
(43) Pub. Date: Dec. 1, 2005

(54) Polarization-maintaining retroreflector apparatus

(76) Inventor: Miao Zhu, San Jose, CA (US)

Correspondence Address: AGILENT TECHNOLOGIES, INC.;Legal Department, DL 429, Intellectual Property Administration, P.O. Box 7599, Loveland, CO, 80537-0599, US

(21) Appl. No.: 10/857,792

(22) Filed: May 28, 2004

(51) Int. Cl. G02B 27/28

(52) U.S. Cl. 359/484; 359/494; 359/529

(57) ABSTRACT

A polarization-maintaining cube corner retroreflector apparatus that provides output light having a desired polarization state. The apparatus has a cube corner retroreflector and a polarization-manipulating optical structure that provides output light having a desired polarization state. The polarization-manipulating optical structure can be one or more polarization-manipulating optical components such as a retarder, an optical rotator formed of a material having optical activity, an optical rotator formed of a material exhibiting the Faraday Effect, or some combination of these components.

### CROSS REFERENCE TO RELATED APPLICATIONS

The present application is related to co-pending applications entitled “SYSTEM USING POLARIZATION-MANIPULATING RETROREFLECTORS”, docket no. 10040352-1, and “DIFFERENTIAL INTERFEROMETER WITH IMPROVED CYCLIC NON-LINEARITY”, docket no. 10040694-1, both filed on even date herewith. The above-related applications are assigned to the same Assignee as the present application and are incorporated herein by reference.

### BACKGROUND OF THE INVENTION

1. Technical Field of the Invention

The present invention relates generally to the field of optical retroreflectors and, more particularly, to a polarization-maintaining cube corner retroreflector apparatus and to methods for constructing a polarization-maintaining cube corner retroreflector apparatus and for maintaining polarization in a cube corner retroreflector apparatus.

2. Description of Related Art

Optical retroreflectors are used in many applications. A solid cube corner retroreflector is a commonly used retroreflector, and provides the advantages of being relatively easy to manufacture and test. A solid cube corner retroreflector can also be readily integrated into complex optical systems or sub-systems.

It is known that an uncoated solid cube corner retroreflector does not preserve the polarization state of the light input into the retroreflector. Metal coatings are sometimes used to mitigate this often undesired property of solid cube corner retroreflectors; however, in some precision measurement applications, residual polarization changes from a metal-coated cube corner retroreflector limit achievable measurement results. Polarization-preserving retroreflectors are known that use a combination of prisms without metal coatings, however, it is generally difficult to manufacture high quality retroreflectors based on such designs.

Accordingly, there is a need for a cube corner retroreflector that provides output light having a desired polarization state without requiring a metal coating and that can be effectively used in precision measurement and other applications. There is also a need for a method for constructing a polarization-maintaining cube corner retroreflector apparatus to provide a desired relationship between polarization states of light input to and output from the polarization-maintaining cube corner retroreflector apparatus.

### SUMMARY OF THE INVENTION

The present invention provides a polarization-maintaining cube corner retroreflector apparatus that provides output light having a desired polarization state, and methods for constructing a polarization-maintaining cube corner retroreflector apparatus and for maintaining polarization in a cube corner retroreflector apparatus. The apparatus has a cube corner retroreflector and a polarization-manipulating optical structure that provides output light having a desired polarization state. The polarization-manipulating optical structure can be one or more polarization-manipulating optical components such as a retarder, an optical rotator formed of a material having optical activity, an optical rotator formed of a material exhibiting the Faraday Effect, or some combination of these components. The one or more polarization-manipulating optical components can be positioned at one or both of an input port and an output port of the cube corner retroreflector.

A polarization-maintaining cube corner retroreflector in accordance with the invention provides output light having a desired polarization state, that may be the same as or different from the polarization state of the input light, without requiring a metal coating; and can be effectively used in precision measurement and other applications.

### BRIEF DESCRIPTION OF THE DRAWINGS

Furthermore, the invention provides embodiments and other features and advantages in addition to or in lieu of those discussed above. Many of these features and advantages are apparent from the description below with reference to the following drawings.

FIG. 1A schematically illustrates an optical system that includes a cube corner retroreflector to assist in explaining the invention;

FIG. 1B schematically illustrates linear polarization-preserving properties of a cube corner retroreflector in a laboratory reference frame to assist in explaining the invention;

FIGS. 2A and 2B are schematic front plan and side perspective views, respectively, of a polarization-maintaining cube corner retroreflector apparatus according to an exemplary embodiment of the invention;

FIGS. 3A and 3B are schematic front plan and side perspective views, respectively, of a polarization-maintaining cube corner retroreflector apparatus according to a further exemplary embodiment of the invention;

FIGS. 4A and 4B are schematic front plan and side perspective views, respectively, of a polarization-maintaining cube corner retroreflector apparatus according to a further exemplary embodiment of the invention;

FIG. 5 is a flow chart that illustrates a method for maintaining polarization in a cube corner retroreflector apparatus according to a further exemplary embodiment of the invention;

FIG. 6 is a flow chart that illustrates a method for constructing a polarization-maintaining cube corner retroreflector apparatus according to a further exemplary embodiment of the invention; and

FIG. 7 is a flow chart that illustrates a method for constructing a polarization-maintaining cube corner retroreflector apparatus according to a further exemplary embodiment of the invention

### DETAILED DESCRIPTION OF THE EXEMPLARY EMBODIMENTS OF THE INVENTION

Embodiments in accordance with the invention provide a polarization-maintaining cube corner retroreflector apparatus, and a method for maintaining polarization in a cube corner retroreflector apparatus.

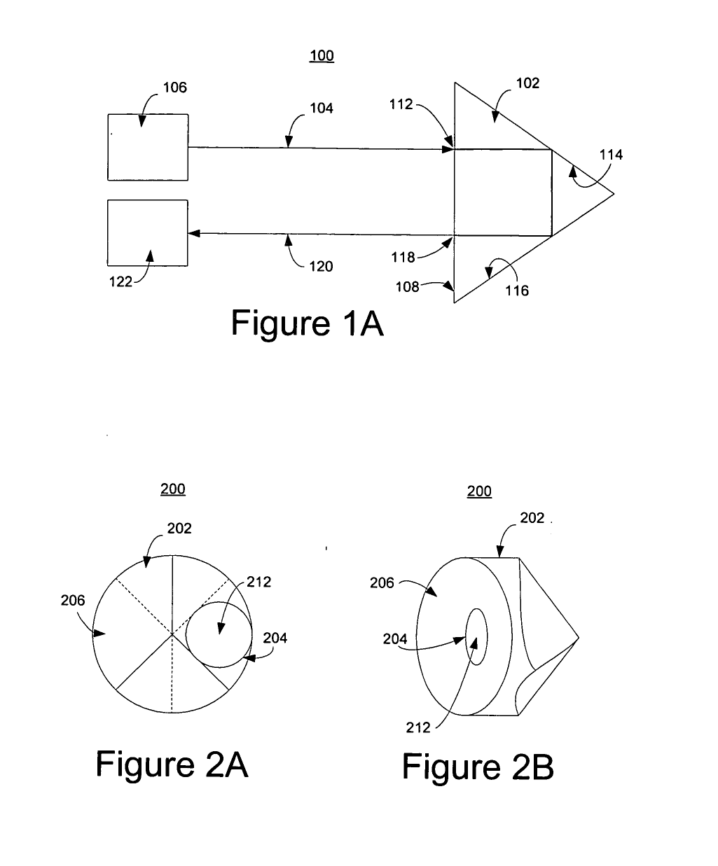

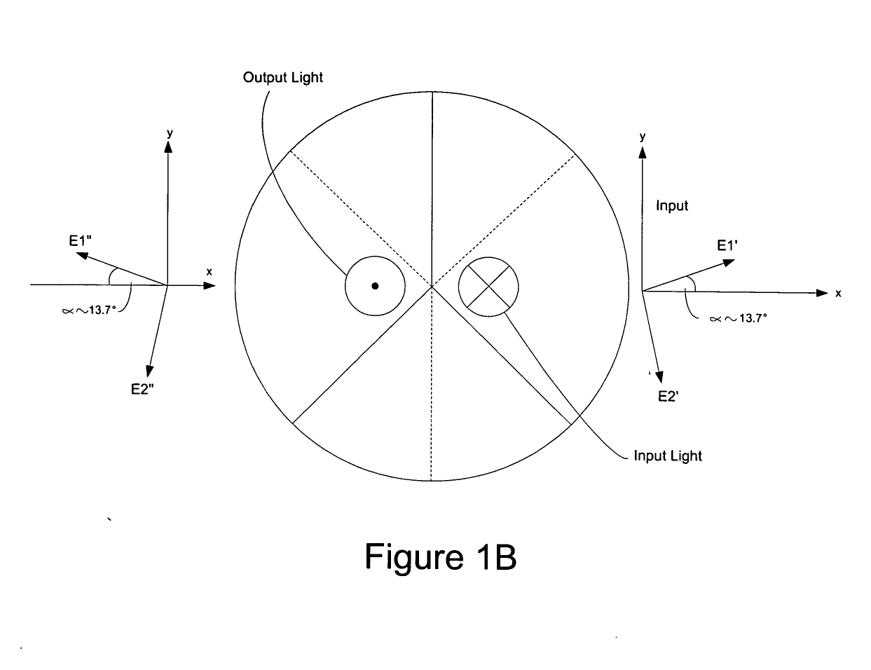

FIG. 1A schematically illustrates an optical system that includes a cube corner retroreflector to assist in explaining the invention. The optical system is generally designated by reference number 100, and includes a solid cube corner retroreflector 102. Cube corner retroreflector 102 is formed of a suitable optical material such as borosilicate crown glass, BK-7 glass or fused silica. Input light 104 from light source 106, for example, a laser light source, enters cube corner retroreflector 102 through surface 108 thereof at location 112, referred to herein as input port 112. Input light 104 is reflected by internal reflecting surfaces of cube corner retroreflector 102, including internal reflecting surfaces 114 and 116 (a third internal reflecting surface cannot be seen in FIG. 1A), and exits cube corner retroreflector 102 as output light 120 through surface 108 thereof at location 118, referred to herein as output port 118. Output light 120 is received by a light receiving device 122, for example, an optical detector.

It is a characteristic of retroreflectors that output light 120 is parallel to input light 104. The parallel input and output light may be spaced from one another, as shown in FIG. 1A, or the output light may be superimposed on the input light.

Optical retroreflectors are used in interferometers and other optical devices, and in optical measurement and testing and other applications. A solid cube corner retroreflector is a commonly used retroreflector because it can be readily integrated into complex optical systems or sub-systems

Many applications require a retroreflector that provides output light having a desired polarization state. Other applications require a retroreflector that preserves the polarization state, especially the linear polarization state. Uncoated solid cube corner retroreflectors, however, do not, in general, preserve the polarization state of the input light. Metal coatings are sometimes used to preserve the polarization state of the input light; however, residual polarization changes from a metal-coated cube corner retroreflector can limit measurement results in some precision measurement applications.

In accordance with exemplary embodiments of the invention, a polarization-maintaining cube corner retroreflector apparatus is provided that comprises a cube corner retroreflector and a polarization-manipulating optical structure. The polarization-manipulating optical structure includes one or more polarization manipulating components such as a retarder (also known as a waveplate), an optical rotator formed of a material having optical activity or of a material exhibiting the Faraday Effect, or some combination of these components. The polarization-manipulating optical structure may function to preserve the polarization state of light input to the apparatus, such that light output from the apparatus will have the same polarization state as the input light; or to transform the polarization state of the input light, such that the output light will have a polarization state different than the input light, for example, the linear polarization rotated by 90 degrees with respect to the linear polarization of the input light.

Embodiments in accordance with the invention rely on the fact that, in general, the eigen-polarization states of a cube corner retrreflector are elliptical polarizations, and the fact that some cube corner retroreflectors, e.g., an uncoated solid cube corner retroreflector, preserve a pair of orthogonal linear polarization states in a reference frame different from a laboratory reference frame. FIG. 1B schematically illustrates the linear polarization-preserving property of a solid cube corner retroreflector in a laboratory reference frame, an xyz-reference frame, where the z-axis extends out of the plane of FIG. 1B.

In particular, FIG. 1B illustrates a view looking from the base of a cube corner retroreflector into the apex of the cube corner retroreflector. E1′ and E2′ is a pair of orthogonal linear polarizations for the input light, and E1″ and E2″ is a pair of orthogonal linear polarizations for the output light. Usually, the optical phase between E1″and E2″ is different from the optical phase between E1′ and E2″. Therefore, the linear polarization along any other direction different from the directions shown in FIG. 1B is not preserved. The numerical value of the rotation angle α depends on the properties of the material used to make the cube corner retroreflector. For an uncoated cube corner retroreflector made of BK-7 glass, a commonly used optical glass, α is approximately 13.7 degrees.

FIGS. 2A and 2B are schematic front plan and side perspective views, respectively, of a polarization-maintaining cube corner retroreflector apparatus according to an exemplary embodiment in accordance with the invention. The polarization-maintaining cube corner retroreflector apparatus is generally designated by reference number 200 and comprises cube corner retroreflector 202 and a polarization-manipulating optical structure comprising one polarization-manipulating optical component 204. Cube corner retroreflector 202 is preferably a solid, uncoated cube corner retroreflector and includes surface 206 having light input port 212 and a light output port (not illustrated in FIGS. 2A and 2B). Cube corner retroreflector 202 also includes internal reflecting surfaces, such as surfaces 114 and 116 illustrated in FIG. 1, for receiving light entering cube corner retroreflector at input port 212, and for reflecting the input light to exit cube corner retroreflector 202 at the output port as output light parallel to the input light, as shown in FIG. 1.

In the exemplary embodiment illustrated in FIGS. 2A and 2B, polarization-manipulating optical component 204 is positioned at input port 212 of cube corner retroreflector 202. It should be understood, however, that the invention is not so limited as the polarization-manipulating optical structure may be positioned at either the input port or the output port, or at both the input port and the output port.

In the exemplary embodiment illustrated in FIGS. 2A and 2B, polarization-manipulating optical component comprises a properly aligned linear retarder having a retardation of π. Alternatively, polarization-manipulating optical component can be a properly fabricated optical rotator. There are no critical alignment requirements between the optical rotator and the cube corner retroreflector.

Polarization-manipulating optical component 204 comprises a disk-shaped optical element having desired properties. The disk can be placed directly on surface 206 of cube corner retroreflector 202 aligned with input port 212, or it can be spaced from surface 206 above input port 212.

A polarization-manipulating optical component implemented as a linear retarder can be formed as a thin disk (e,g., about 1 mm thick, depending on the material and the design) of quartz crystal, mica, certain polymers and other materials, and functions by having slow and fast principal axes that propagate differently polarized light at different rates. A polarization-manipulating optical component implemented as an optical rotator can be formed of a material having optical activity; or of a material exhibiting the Faraday Effect, either by having the required magnetic field applied to the material externally or by being built-in to the material. An optical rotator, for example, can be formed of left-handed or right-handed quartz crystal that functions to rotate the linear polarization state of the input light by a desired angle.

Polarization-manipulating optical component 204 can be designed to function as a polarization-preserving optical component, such that the output light has the same polarization state as the input light, or as a polarization-transforming optical component, such that the output light has a different polarization state than the input light, for example, rotated at 90 degrees relative to the input light.

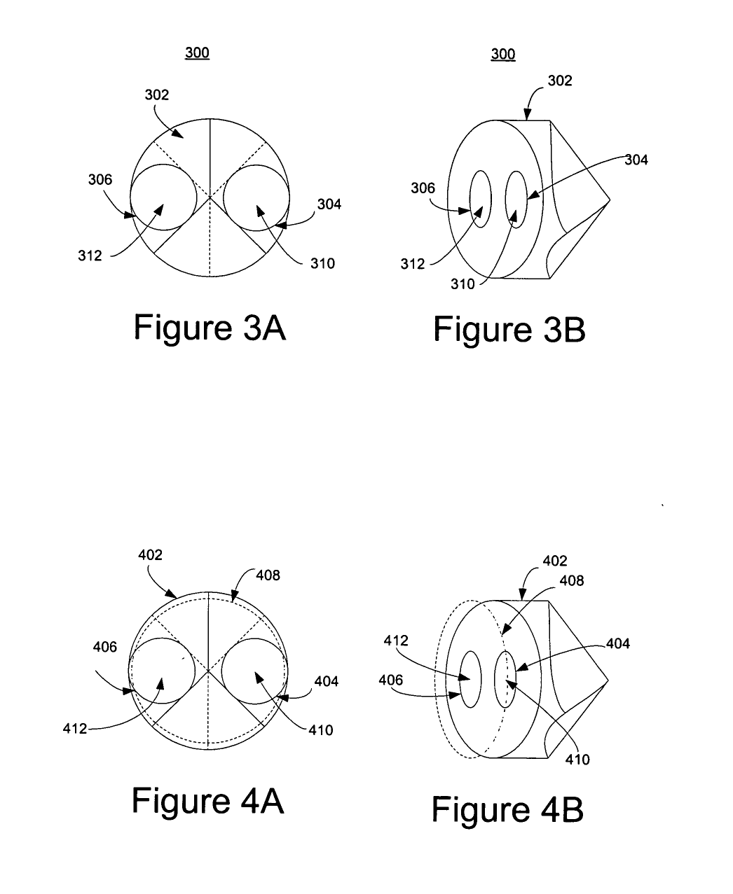

FIGS. 3A and 3B are schematic front plan and side perspective views, respectively, of a polarization-maintaining cube corner retroreflector apparatus according to another exemplary embodiment in accordance with the invention. The apparatus is generally designated by reference number 300 and comprises cube corner retroreflector 302 and a polarization-manipulating optical structure comprising two polarization-manipulating optical components 304 and 306. Polarization-maintaining cube corner retroreflector apparatus 300 comprises a polarization-preserving cube corner retroreflector apparatus in which the polarization states of both the input and output light are the same; although in other exemplary embodiments, polarization-maintaining cube corner retroreflector apparatus can also comprise a polarization-transforming cube corner retroreflector apparatus in which the polarization states of the input and output light are different. Optical component 304 is positioned at input port 310 of cube corner retroreflector 302, and optical component 306 is positioned at output port 312 of cube corner retroreflector 302.

As in the exemplary embodiment illustrated in FIGS. 2A and 2B, polarization-manipulating optical components 304 and 306 can be implemented as optical retarders or as optical rotators formed of a material having optical activity or exhibiting the Faraday Effect. Polarization-manipulating optical components 304 and 306 may be formed from different elements or may be cut from a single optical element so that differences in their optical properties are minimized. In an exemplary embodiment in accordance with the invention, polarization-maintaining optical components 304 and 306 may comprise a left-handed rotator and a right-handed rotator having the same rotation angle and cut from a left-handed and a right-handed quartz crystal, respectively, so that they have substantially the same thickness. One surface of the two rotators can be attached to the surface of the cube corner retroreflector, and another optical component can be attached to the other surfaces of the two rotators since they are in approximately the same plane. This can be important when constructing optical systems or subsystems.

FIGS. 4A and 4B are schematic front plan and side perspective views, respectively, of a polarization-maintaining cube corner retroreflector apparatus according to another exemplary embodiment in accordance with the invention. The apparatus is generally designated by reference number 400 and comprises cube corner retroreflector 402 and a polarization-manipulating optical structure comprising three polarization-manipulating optical components 404, 406 and 408. Optical components 404 and 406 correspond to optical components 304 and 306 in FIG. 3, and are positioned at input and output ports 410 and 412, respectively; and element 408 comprises an additional linear retarder to compensate for the optical phase shift between two eigen-polarizations. Corner cube retroreflector apparatus 400 preserves all polarization states, i.e. the apparatus is free of birefringence.

As in the exemplary embodiments illustrated in FIGS. 2A and 2B and in FIGS. 3A and 3B, polarization-manipulating optical components 404, 406 and 408 can be implemented as optical retarders or as optical rotators formed of a material having optical activity or exhibiting the Faraday Effect. The components can also be formed from different optical elements or cut from the same optical element, and can be designed to provide either a polarization-preserving or a polarization-transforming cube corner retroreflector apparatus.

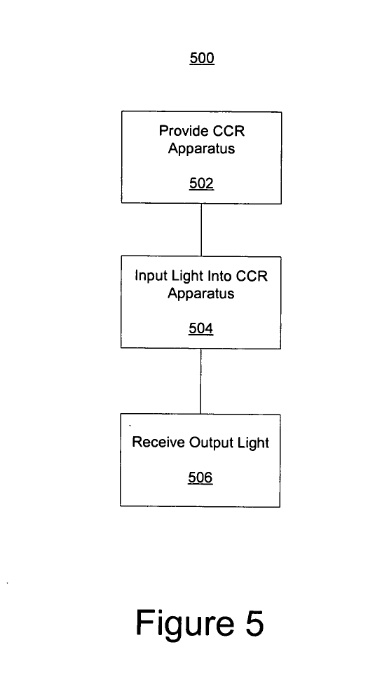

FIG. 5 is a flow chart that illustrates a method for maintaining polarization in a cube corner retroreflector apparatus according to another exemplary embodiment in accordance with the invention. The method is generally designated by reference number 500 and begins by providing a cube corner retroreflector apparatus that includes a cube corner retroreflector and a polarization-manipulating optical component (step 502). Light is then input into the cube corner retroreflector apparatus at an input port thereof to provide output light having a desired polarization state (step 504). The desired polarization state may be the same as the polarization state of the input light or a different polarization state than the input light. The output light is received by a light receiving member (step 506), for example, by an optical detector.

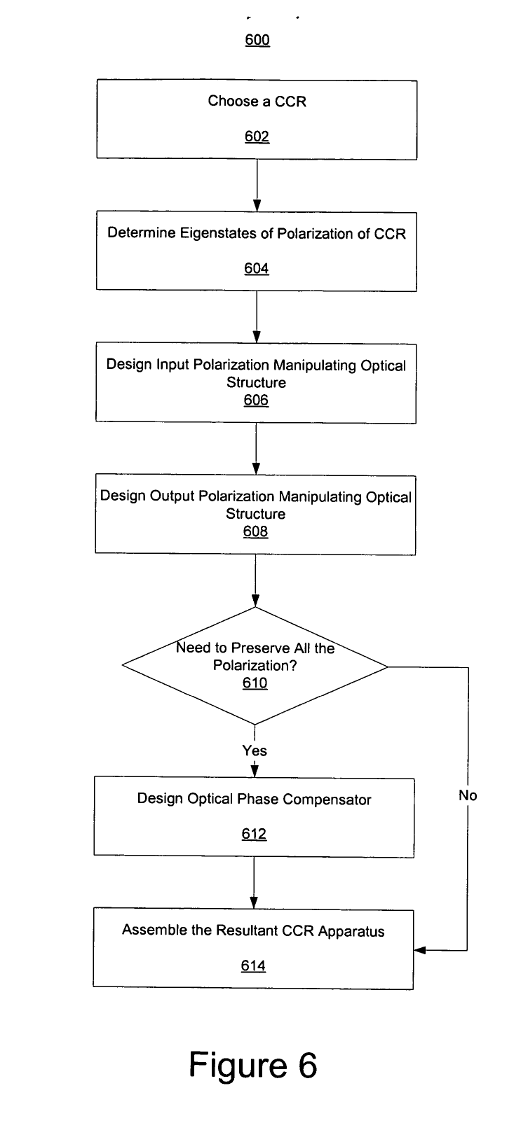

FIG. 6 is a flow chart that illustrates a method for constructing a polarization-maintaining cube corner retroreflector apparatus according to an exemplary embodiment in accordance with the invention. The method is generally designated by reference number 600 and begins by choosing a cube corner retroreflector according to specific requirements of the intended application (step 602). The eigenstates of the polarization of the chosen cube corner retroreflector are then determined (step 604). Polarization manipulating optical structures for input light and output light are then designed in steps 606 and 608, respectively, according to desired input and output polarization states. One example of the polarization-manipulating optical structure is a combination of three linear retarders with retardations of π, π/2 and π. It is known that such a combination of linear retarders transforms a given polarization state to another polarization state provided the fast axes of the retarders are properly aligned. Alternatively, a specially designed retarder can replace this combination of three linear retarders.

A determination is then made whether all the polarization states are to be preserved (step 610). If all the polarization states are to be preserved (“Yes” output of step 610), a phase compensator is designed (step 612) before the resultant cube corner retroreflector apparatus is assembled (step 614). If all the polarization states are not to be preserved (“No” output of step 610), a phase compensator need not be designed before assembling the cube corner retroreflector apparatus.

By using the properties of the cube corner retrorelector obtained in step 604, it should be understood that various design combinations can be provided in steps 606 and 608 to achieve the same input and output polarizations.

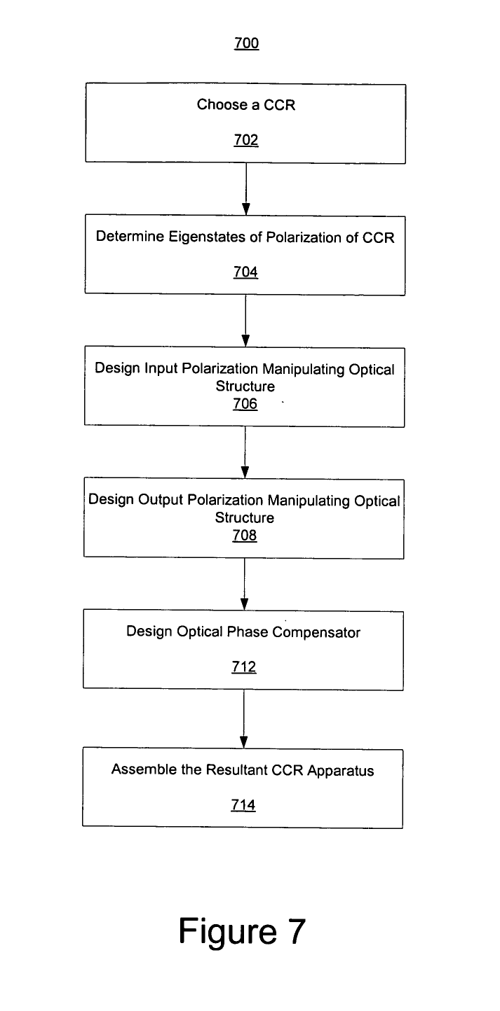

FIG. 7 is a flow chart that illustrates a method for constructing a cube corner retroreflector apparatus according to another exemplary embodiment in accordance with the invention. The method is generally designated by reference number 700, and comprises a method for constructing a cube corner retroreflector apparatus that preserves all polarization states. As in the method described with reference to FIG. 6, the method begins begins by choosing a cube corner retroreflector according to specific requirements of the intended application (step 702), and determining the eigenstates of the polarization of the chosen cube corner retroreflector (step 704). A polarization-manipulating optical structure that converts a pair of orthogonal linear polarization states of the input light into the eigenstates of the polarization of the chosen cube corner retroreflector is then designed (step 706). A polarization-manipulating optical structure that converts the eigenstates of the polarization of the chosen cube corner retroreflector into a pair of orthogonal linear polarization states, which are the same as the polarization states in the input light is then designed (step 708).

A linear retarder is used to compensate for the optical phase introduced by the cube corner retroreflector (step 712), and the resultant cube corner retroreflector apparatus is assembled (step 714).

While what has been described constitutes exemplary embodiments of the present invention, it should be recognized that the invention can be varied in many respects without departing therefrom. Because the invention can be varied in many ways, it should be understood that the invention should be limited only insofar as is required by the scope of the following claims.

1. A cube corner retroreflector apparatus, comprising:
a cube corner retroreflector, the cube corner retroreflector including an input port for receiving input light, and an output port for outputting output light; and
a polarization-manipulating optical structure at at least one of the input port and the output port for providing the output light with a desired polarization state.

2. The apparatus according to claim 1, wherein the polarization-manipulating optical structure comprises at least one retarder.

3. The apparatus according to claim 1, wherein the polarization-manipulating optical structure comprises at least one optical rotator.

4. The apparatus according to claim 3, wherein at least one of the at least one optical rotator is formed of a material having optical activity.

5. The apparatus according to claim 3, wherein at least one of the at least one optical rotator is formed of a material exhibiting the Faraday Effect.

6. The apparatus according to claim 1, wherein said polarization-manipulating optical structure comprises at least one optical retarder and at least one optical rotator.

7. The apparatus according to claim 1, wherein the polarization-manipulating optical structure comprises a first polarization-manipulating optical component at the input port and a second polarization-manipulating optical component at the output port.

8. The apparatus according to claim 7, wherein at least one of the first and second polarization-manipulating optical components comprises at least one retarder.

9. The apparatus according to claim 7, wherein at least one of the first and second polarization-manipulating optical components comprises at least one optical rotator.

10. The apparatus according to claim 7, wherein the first and second polarization-manipulating optical components are cut from the same optical element.

11. The apparatus according to claim 7, wherein the first and second polarization-manipulating optical components comprise one left-handed rotator and one right-handed rotator that have substantially the same thickness.

12. The apparatus according to claim 7, wherein the polarization-manipulating optical structure further comprises a third polarization-manipulating optical component, the third polarization-manipulating optical component provided at at least one of the input port and the output port.

13. The apparatus according to claim 12, wherein the first and second polarization-manipulating optical components comprise one left-handed rotator and one right-handed rotator that have substantially the same thickness, and the third polarization-manipulating optical component comprises a linear retarder.

14. The apparatus according to claim 12, wherein the third polarization-manipulating optical component comprises one of a retarder and an optical rotator.

15. The apparatus according to claim 14, wherein the third polarization-manipulating optical component comprises an optical rotator, and wherein the optical rotator is formed of one of a material having optical activity and a material exhibiting the Faraday Effect.

16. The apparatus according to claim 1, wherein the apparatus comprises one of a polarization-preserving cube corner retroreflector apparatus in which the output light has the same polarization state as the input light, and a polarization-transforming cube corner retroreflector in which the output light has a different polarization state than the input light.

17. An optical system, comprising:
a light source for providing input light; and
a cube corner retroreflector apparatus, the cube corner retroreflector apparatus including:
an input port for receiving the input light, and an output port for outputting output light; and
a polarization-manipulating optical structure at at least one of the input and output port for maintaining a polarization state of the output light.

18. The optical system according to claim 17, wherein the polarization-manipulating optical structure comprises at least one retarder.

19. The optical system according to claim 17, wherein the polarization-manipulating optical structure comprises at least one optical rotator.

20. The optical system according to claim 19, wherein the optical rotator comprises one of a material having optical activity and a material exhibiting the Faraday Effect.

21. The optical system according to claim 17, wherein the polarization-manipulating optical structure comprises at least one optical retarder and at least one optical rotator.

22. A method for maintaining polarization in a cube corner retroreflector apparatus, comprising:
providing a cube corner retroreflector apparatus that includes a cube corner retroreflector and a polarization-manipulating optical component; and
inputting input light into the cube corner retroreflector apparatus at an input port of the cube corner retroreflector to provide output light having a desired polarization state.

23. The method according to claim 22, wherein the desired polarization state is the same as the polarization state of the input light.

24. The method according to claim 22, wherein the desired polarization state is different from the polarization state of the input light

25. The method according to claim 22, wherein the providing comprises choosing a cube corner retroreflector according to requirements, designing the polarization-manipulating optical component according to desired input light and output light polarization states, and assembling the cube corner retroreflector apparatus.

26. The method according to claim 25, wherein the cube corner retroreflector apparatus preserves all polarization states.
